(19) United States
(12) Patent Application Publication
(10) Pub. No.: US 2009/0173589 A1
(43) Pub. Date: Jul. 9, 2009

(54) System and Method for Generating Electricity from Automobile Traffic

(76) Inventor: Mark J. Nejmeh, Bradley Beach, NJ (US)

Correspondence Address: CAPITAL LEGAL GROUP, LLC, 1100 River Bay Road, Annapolis, MD, 21409, US

(21) Appl. No.: 11/971,653

(22) Filed: Jan. 9, 2008

(51) Int. Cl. H02J 3/00

(52) U.S. Cl. 191/2; 290/1 R

(57) ABSTRACT

A system and method for generating electricity from the movement of vehicles over a traveling surface is provided. In one embodiment, the system includes a stator having a plurality of windings, a rotor configured to rotate and configured to be mounted adjacent the traveling surface, the rotor having a perimeter and a plurality of magnets mounted to the perimeter and wherein each magnet creates a magnetic field and is mounted to the rotor so that the magnetic field of the magnets induces an electric current in the windings of the stator during rotation of the rotor, and results in an attractive force between the magnets and the vehicles moving over the traveling surface to urge the rotation of the rotor.

### FIELD OF THE INVENTION

The present invention generally relates to systems and methods for generating electricity, and more particularly to systems and methods for generating electricity from moving vehicles, such as moving automobiles.

### BACKGROUND OF THE INVENTION

Electricity generation is the process of converting some form of energy into electricity. For electric utilities, it is the first process in the delivery of electricity to consumers. Many early power plants generate electricity from water power or coal. In the United States electricity is derived mainly from fossil fuel sources, e.g., coal, petroleum and natural gas. However, the cost of obtaining such fuels is becoming increasingly expensive. Further, the processes for extracting such fuels and the burning of such fuels to produce electricity are having increasingly negative effects on the environment, weather patterns, climate, economy and geopolitical systems. Accordingly, there is a need for alternative sources of power.

Examples of alternative energy sources include solar energy, tidal harnesses, wind generators, and geothermal sources. Still other sources may include nuclear power, electrochemical electricity generation (e.g., batteries), and solid-state power generation (e.g., thermoelectric devices, thermophotovoltaic systems).

Many of these alternative sources have not achieved widespread use because of their complexity and cost. Accordingly, there continues to be a need for additional sources of electrical power to replace or supplement the use of fossil fuels. The present invention provides another such source.

### SUMMARY OF THE INVENTION

The present invention provides a system and method for generating electricity from the movement of vehicles over a traveling surface. In one embodiment, the system includes a stator having a plurality of windings, a rotor configured to rotate and configured to be mounted adjacent the traveling surface, the rotor having a perimeter and a plurality of magnets mounted to the perimeter and wherein each magnet creates a magnetic field and is mounted to the rotor so that the magnetic field of the magnets induces an electric current in the windings of the stator during rotation of the rotor, and results in an attractive force between the magnets and the vehicles moving over the traveling surface to urge the rotation of the rotor.

The invention will be better understood by reference to the following detailed description taken in conjunction with the accompanying drawings.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 illustrates an electricity generating system, according to an example embodiment of the present invention;

FIG. 2 illustrates an electricity generating system, according to another example embodiment of the present invention;

FIG. 3 illustrates an example system for generating electricity, according to an example embodiment of the present invention;

FIG. 4 illustrates a portion of an electricity generating unit having a rotor and a current-generating stator, according to an example embodiment of the present invention;

FIG. 5 illustrates an example processing subsystem which may accompany the electricity generating systems, according to an example embodiment of the present invention;

FIG. 6 illustrates a portion of an electricity generating unit having a conical rotor with magnets for generating a magnetic field which induce current into an axially positioned stator, according to an example embodiment of the present invention;

FIG. 7 shows an exploded view of the electricity generating unit portion of FIG. 6;

FIG. 8 illustrates an example system for generating electricity, according to another example embodiment of the present invention;

FIG. 9 illustrates a portion of an example system for generating electricity, according to an example embodiment of the present invention; and

FIG. 10 is a flow chart of a process for generating electricity according to an example embodiment of the present invention.

### DETAILED DESCRIPTION OF ILLUSTRATIVE EMBODIMENTS

In the following description, for purposes of explanation and not limitation, specific details are set forth in order to provide a thorough understanding of the present invention. However, it will be apparent to one skilled in the art that the present invention may be practiced in other embodiments that depart from these specific details. Detailed descriptions of well-known devices and technologies are omitted so as not to obscure the description of the present invention.

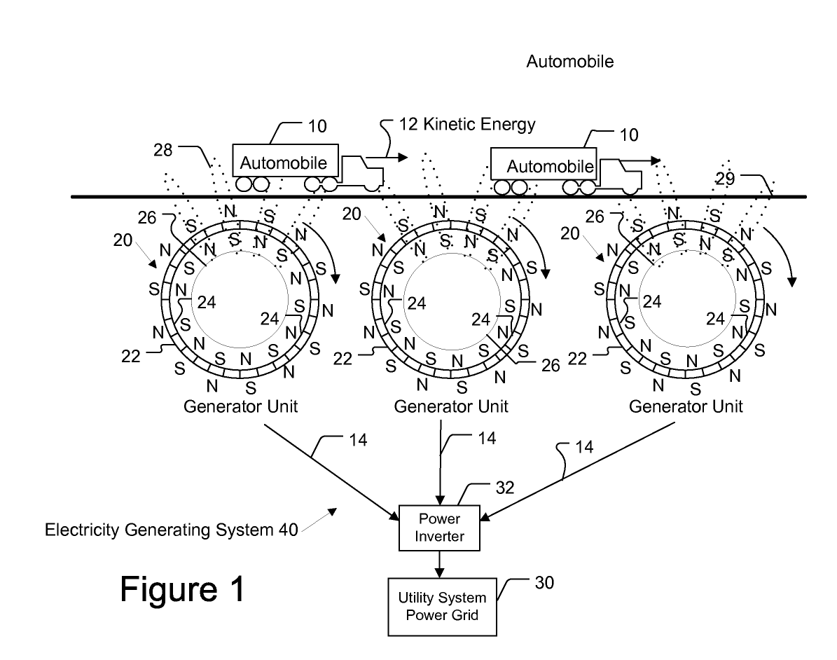

FIG. 1 shows an example embodiment of the present invention in which the kinetic energy 12 of automobiles 10 is used to generate electricity 14. While each automobile 10 may include non-magnetic material, each also includes one or more components made of magnetic material. The automobiles 10 move along a traveling surface 29 under their own power or due to gravity (because they are traveling down a hill). An electricity generating system 40 is situated along the path of the moving automobiles 10 and includes magnetic generator units 20, each having a rotor 22 configured to rotate. It is worth noting that FIG. 1 is not drawn to scale and in practice, the generating units 20 typically would be smaller than the automobiles 10. As the automobiles 10 move through a magnetic field emitted by electricity generating units 20, the force caused by the magnetic attraction of the magnets 24 to the passing automobiles 10 causes the rotors 22 of generating units 20 to rotate. The rotation of each rotor 22 induces current to flow in an associated stator 26 to thereby produce electricity.

Each electricity generating unit 20 includes the rotor 22 having multiple magnets 24, (e.g., permanent magnets; electromagnetics) and the stator 26. The magnets 24 create the magnetic field 28 through which the moving automobiles 10 traverse. As an automobile 10 moves over a traveling surface 29, and through the magnetic field 28, the attractive force between the magnetic material of the automobiles 10 and the magnets 24 of the rotor 22 causes the rotor 22 to rotate. The rotation of the rotor 22 about the stator 26 induces the electrical current 14. In one embodiment the current 14 flows to one or more power inverters 32 to convert the electricity from to direct current (DC) to alternating current (AC), and then to a power grid 30 (e.g., a public power distribution system). Accordingly, electricity is generated from the movement of automobiles 10 relative to one or more electricity generating units 20 so as to form an electricity generating system 40.

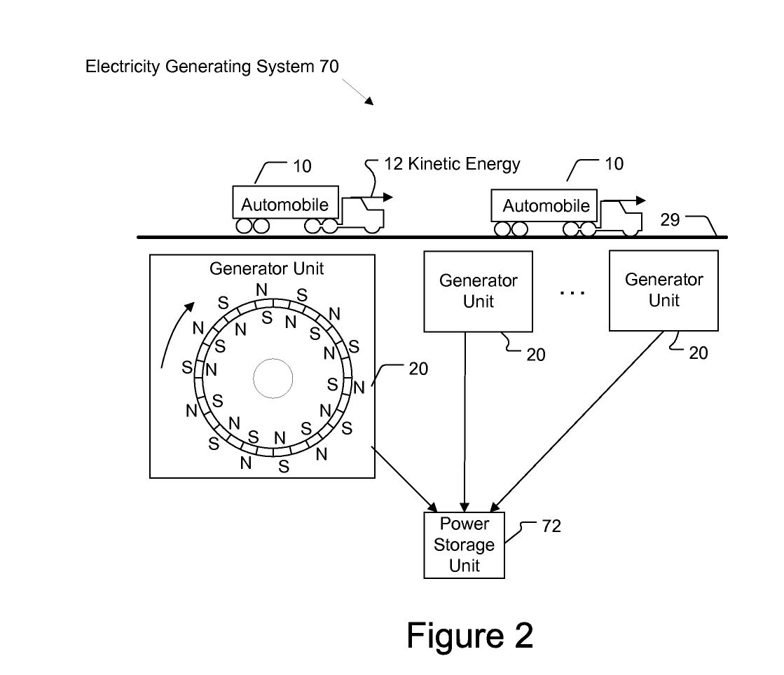

FIG. 2 shows an alternative embodiment of a portion of an electricity generating system 70 which stores the generated electricity in a power storage unit 72 (e.g., one or more batteries), rather than coupling the generated power to the power grid 30. The electricity generating system 70 includes multiple electricity generating units 20 which are electrically coupled to the power storage unit 72. For either system 40 or 70, the generated electricity, also or in addition, may be distributed locally to provide power to nearby homes, buildings, street lamps, equipment, billboards, street signs, or other devices that consume electrical energy.

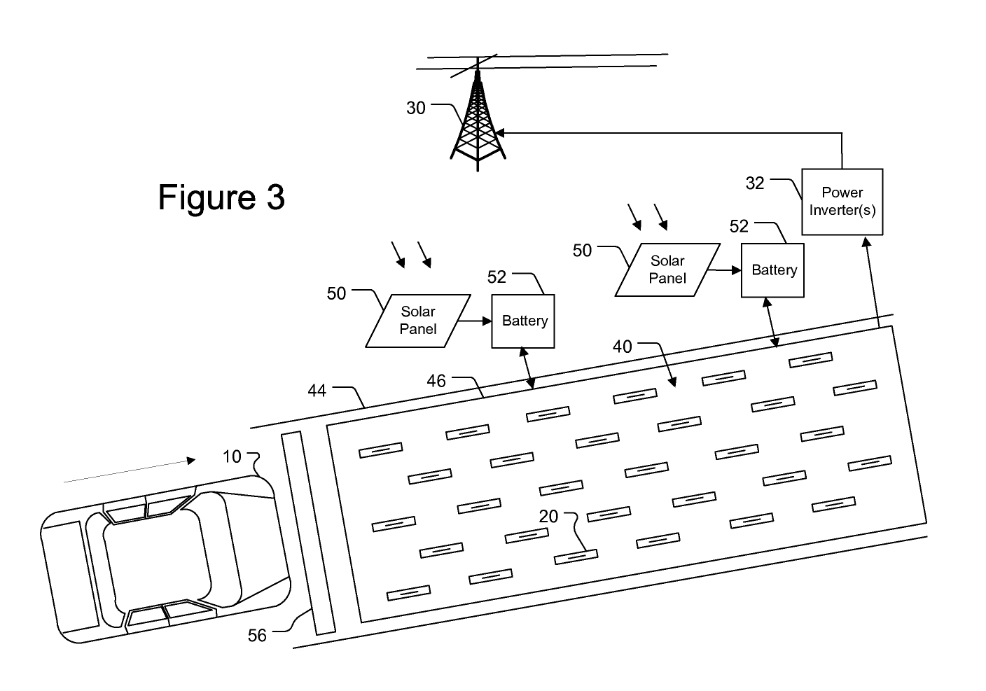

In the above example, automobiles 10 are the moving “vehicles.” In other embodiments, movement of containers, carts or carriers, such as used on a manufacturing line, recycling line, mining line, or construction line, which attract the magnets may be used to rotate the rotors 22. FIG. 3 shows an embodiment of the present invention for generating electricity from the kinetic energy of automobiles 10 moving along a roadway 44. An embodiment of an electricity generating system 40 is embedded into the roadway 44. More specifically, a non-magnetic grate 46 may serve as part of the roadway 44 to support vehicular traffic. For example, the grate 46 may be non-metallic so that magnetic attraction between the magnets 24 of the rotor 22 and the automobiles 10 is not substantially dampened. Multiple generator units 20 may be located beneath the grate 46 so as to allow the magnetic flux from the highest magnets to couple to the automobiles traveling above.

In an example embodiment the grate 46 may be a structural carbon resinous grate supported by a concrete housing (not shown). For example, a carbon resin material such as pyron or panex may be used to form the grate 46. In a specific embodiment the grate may support up to 60 tons of weight. Geophysical compression testing may be performed on the grate 46 and underlying housing prior to complete installation of the generating units 20. Conventional road construction practices and quality assurances may be implemented. The grate 46 may be installed to be flush with the adjacent road surface and generally level so as to provide a smooth roadway 44 with a generally seamless transition between the standard road surface (e.g., adjacent asphalt) and the grate 46. In various implementations the system 40 may be situated in a prepared surface, such as along a highway, railway or bridge.

The concrete housing supporting the grate 46 may be reinforced with non-metallic carbon and resinous rebar, and designed to enable convenient water drainage and debris removal. The housing may be grounded, such as by a stainless steel rod, (e.g., a ¾ inch diameter rod). The rod may extend through the housing and ultimately be clamped via a copper wire or other conductor to the power inverter 32 to thereby ground the power inverter. Caution is to be taken to adequately ground the system 40 and implement safe electrical practices. In addition, in one embodiment the support structure is constructed so that no magnetic materials are located near the units 20 to thereby prevent the magnets from being attracted to the support structure and impeding generation of electricity.

In this embodiment a single grate 46 covers many generating units 20. In other embodiments, multiple grates 46 are positioned in the roadway 44 with underlying housings holding one or more generating units 20. In such an embodiment adjacent areas between the grates may be concrete, polymer asphalt or other asphalt. In a specific embodiment the grate(s) 46 may have a checkerboard pattern with staggered openings.

Each generator unit 20 also may include a housing (not shown) and be situated within the concrete housing underlying the grate 46. The generator unit housing also may be formed by a carbonous or resinous rebar and may be pre-cast or poured in place.

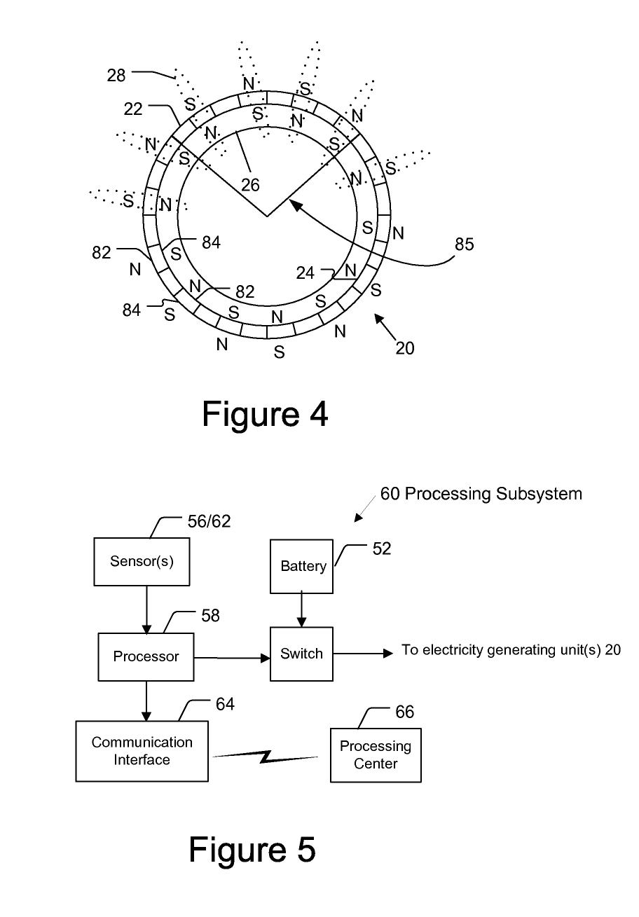

As shown in FIG. 4, the rotor 22 includes multiple magnets 24. In some embodiments the magnets 24 are permanent magnets. In other embodiments the magnets are electromagnetics. For either configuration each magnet 24 has one pole facing generally outward in a radial direction, which will be attracted to moving vehicles. Each magnet may also include another pole generally facing inward along the radial direction and toward the stator 26 (shown schematically). For example, a given magnet 24 may have a north pole 82 facing outward and a south pole 84 facing inward. In such instance, an adjacent magnet 24 may have the opposite orientation with the south pole 84 facing outward and the north pole 82 facing inward. As described below, in other embodiments the magnetic field 28 may have an orientation other than radial. The magnetic fields 28 of the magnets 22 extend radially outward and may couple with passing automobiles. The magnetic fields of the magnets 28 also extend radially inward to cause electricity to be generated in the windings of the stator 26. For embodiments in which permanent magnets are used, all the magnets would have a magnetic field 28 (although the figure illustrates only some of the fields 28). Two (or more) wires (not shown) may be attached to the stator 26 to conduct generated electricity from the stator 26 to the power inverter or battery.

For an embodiment including electromagnetics, the magnetic field 28 may be induced by conducting a current through a coil of each electromagnet (EM). In one embodiment, the system 40 may include solar panels 50 (see FIG. 3) with photovoltaic cells for generating electrical current from sunlight. The current from the solar panels 50 may be stored in one or more batteries 52. A wire couples the battery 52 to the coil of each electromagnet 24. For example, a pair of wires may connect the batteries 52 to one or more brushes fixed adjacent to the rotor 22 and to ground. As the rotor 22 rotates the coils are connected to the brushes making contact and receiving electrical current. The brushes and coil contacts are positioned so that at any given time, the brushes are energizing at least some of the EM coils. In a given embodiment the brushes may be positioned so as to energize only the magnets 22 most adjacent to the road surface (e.g., the top 35%). For a rotor wheel oriented perpendicular to the roadway, the brushes may be mounted so as to energize approximately 33% of the coils between ten o'clock and two o'clock as indicated by lines 85.

In a given embodiment the batteries 52 (see FIG. 3) may be charged from the solar panels 50, the electricity generating units 20, or the power grid 30. In some embodiments, a switch may be included which senses the batteries' 52 charge. When the battery charge reaches an upper threshold capacity, the switch directs electric current from the solar panel 50, or electricity generating unit(s) 20 away from the batteries 52 and to the grid 30 (via the power inverter). When the battery charge reaches an alternate lower threshold capacity, the switch may direct current from the solar panel 50, the electricity generating unit(s) 20, or the power grid 30 to the batteries 52.

In some embodiments the power derived from the solar panels 50 also may contribute to, initialize, or maintain the momentum of the rotor 22. For example the amount of current applied to the EM coils may be controlled to increase the attractive force between the passing automobiles 10 and the rotor magnets 24. In addition, when approaching traffic is sensed, electricity from the batteries 52 or solar panels 50 may be directed to the windings of the stator 26 to cause the rotor to rotate (in which case the generating unit 20 acts as a motor instead of a generator) to initialize rotation of the rotor so that improved rotation of the rotor is caused by the automobiles.

In one embodiment of the electricity generating system 40, a sound sensor 56 may be positioned along the roadway 44 to detect automobiles approaching the electricity generating units 20. As traffic approaches the electricity generating system 40, the sound sensor 56 detects the sound of the oncoming vehicle 42 or traffic. The sound sensor 56, periodically, is sampled by a processor 58 (see FIG. 5), which when traffic is initially detected, switches on power from the batteries 52 to the EM coils to create the magnetic fields 28 (and, in some instances, cause an initial rotation of the rotor 22).

FIG. 5 shows an example embodiment of a processing subsystem 60, including the sound sensor(s) 56. One or more sound sensors 56 are coupled to a processor 58. The subsystem 60 may be powered by the battery 52 or other power source. In some embodiments, the sound information may be used to detect the engine size of an oncoming automobile 10. The vehicle size information, in turn may be used to estimate the strength of the magnetic attraction that may occur as the automobile 10 passes over the electricity generating units 20. The strength of the magnetic fields 28 induced by EM coils may in turn be adjusted according to the size of the automobile 10 and desired force of attraction to optimize or improve the electricity generation from the units 20. In some embodiments visual imaging sensing device(s) 62 may be included, also or alternatively, to identify a vehicle's license plate and vehicle type. Such information may be used to credit the vehicle owner with some of the benefit that results from their vehicle passing through the magnetic fields of the electricity generating units 20. For such an embodiment, the subsystem 60 may also include a communication interface 64 for communicating information to a processing/accounting center 66 to manage the credits.

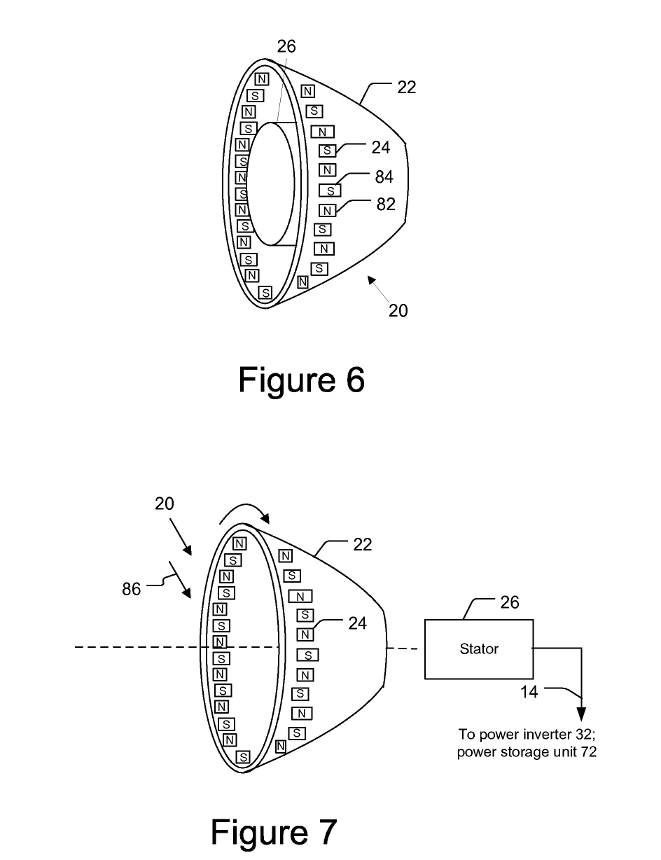

FIG. 6 shows an example embodiment of a portion of an electricity generating unit 20. Note that the housing for the unit 20 is not shown. The electricity generating unit 20 includes a rotor 22 and a stator 26. In various embodiments the rotor 22 may have varying shapes and orientations. In the illustrated embodiment, the rotor 22 has a bowl or cone shape. In other embodiments, the rotor 22 may have a wheel or cylindrical shape. In each embodiment the rotor 22 rotates in a circular pattern about a generally fixed stator 26. The rotor 22 includes magnets 24 as described above. For an embodiment in which the magnets 24 are EM coils, brushes may be included to serve as a contact for conducting electrical current to the EM coils. Such current causes the EM coils to generate the magnetic field 28. The brushes are not shown.

In some electricity generating systems 40, the rotor 22 may be turned not only from the magnetic attraction of the passing vehicle, but also from the downdraft or sidedraft of displaced air caused by the passing automobiles 10 (FIG. 3) or other moving assemblies. Although the rotor 22 is shown with a vertical orientation (e.g. FIGS. 1-3 relative to a surface 29 along which the automobile 10 move), in some embodiments the rotor 22 may have a horizontal orientation (e.g., and be situated along a side of the traveling surface 29) or an orientation between horizontal and vertical. In particular, the orientation may be designed to be at a specific pitch and angle relative to the expected path of the overhead automobile 10 so as to effectively capture a wind air displacement force 86 (see FIG. 7) and direct the rotor 22 into a rotary motion about the stator 26. The magnets 24 may be situated to generate a magnetic field generally perpendicular to the traveling surface 29 or to have a directional component generally perpendicular to the surface 29. Thus for a vertically oriented rotor 22, the magnets may generate a magnetic field in a radial direction relative to the rotor 22. For a horizontally oriented rotor 22, the magnet sources 24 instead may be situated to generate a magnetic field in a direction somewhere between parallel and perpendicular to the rotor 22. In particular, for a horizontally-oriented rotor 22, it may be desirable that the magnetic field be toward the perpendicular (e.g., have a perpendicular directional component), so as to have the highest attraction vector with the vehicles directly overhead. However, it is desirable that the magnetic field 28 also be toward the parallel (e.g. has a parallel directional component), so as to induce current to flow at the stator 26—and thus generate electricity. Accordingly, the magnetic field for the horizontally-oriented rotor 22 may have a vector including both parallel and perpendicular directional components. The specific orientation of the rotor 22, and the specific directional vectors of the magnetic fields 28 generated by the magnet sources 24 may be designed to achieve optimal electricity generation for a given traffic volume, vehicle size, or traffic pattern. Accordingly, such orientation and directional vectors may vary according to the embodiment.

In the generally cone-shaped rotor 22 of FIGS. 6 and 7 the rotor 22 includes a plurality of magnets 24 along its periphery. In an example embodiment one or more rows of magnets 24 may be situated along the cone-shaped rotor 22 toward a specific end, (e.g., the wider end). In some embodiments a row of the magnets 24 may be flush with the rotor end, or otherwise near the rotor end. As previously described, the magnets 24 may be permanent magnets or electromagnetics. For embodiments including permanent magnets, the magnets may be of varying size, shape and strength. Such magnets 24 may be mounted to the rotor 22, such as by a stamping process, a gluing process or another mounting methodology. Similarly for embodiments including EM coils, the coils may be of varying size, shape, and strength.

The stator 26 serves as an armature for the electricity generating unit 20, while the rotor 22 having the magnets 24 serves as the field component. In some embodiments the stator 26 may be cone shaped to mate with the shape of the rotor 22, but includes enough space there between to allow displaced air from moving automobiles to assist in rotating the rotor 22. In other embodiments the stator 26 may be cone shaped to mate with the shape of the rotor 22, but include a passage through the stator's center to allow air to flow. The rotor 22 may include fan fins on its small end that, when air flows through the small end causes the rotor 22 to rotate.

The stator/armature 26 carries current, and therefore includes a conductor windings oriented generally normal to the magnetic fields 28 and to the rotor direction of motion. As described above, in some embodiments the orientation may be away from the normal, but include a normal directional component. As the rotor turns, the change in the magnetic fields 28 induces current to flow in the windings of the stator 26. The greater the rate of change and the greater the strength of the magnetic fields 28, the larger the current that is induced. Thus, the faster that the rotor 22 turns, the more electricity that is generated by a given electricity generating unit 20.

In a given embodiment each electricity generating unit 20 creates its own electricity which is combined with electricity from other electricity generating units 20 at one or more power inverters 32 to be sent into the power grid 30. Alternately, the electricity is stored as power at a power storage device 72, such as for local distribution to street lights, homes, buildings, or other users of electricity.

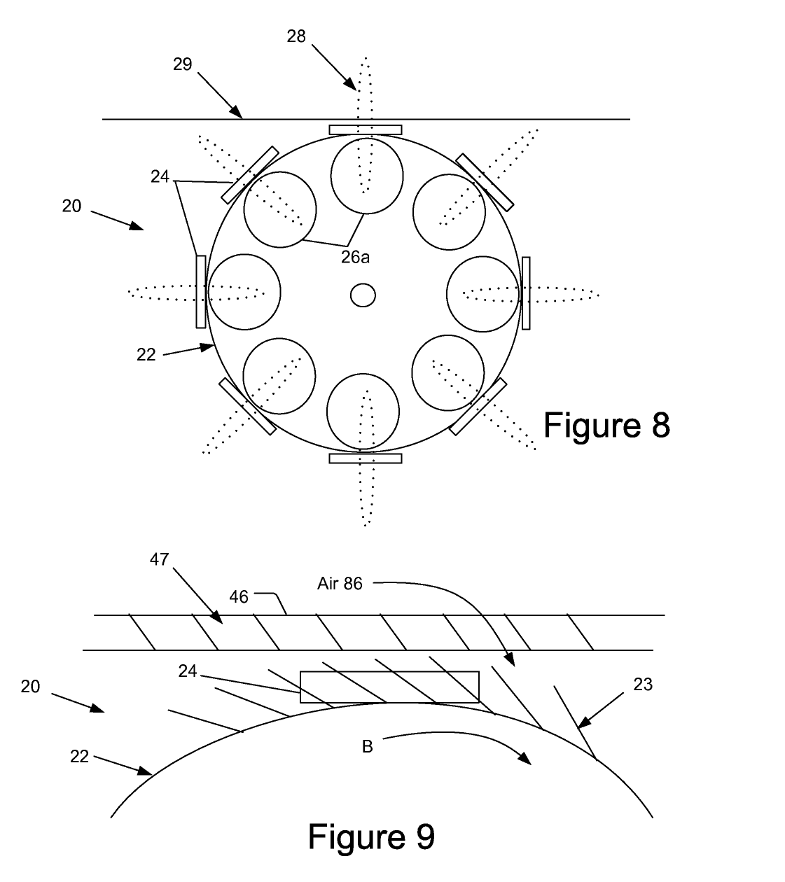

FIG. 8 illustrates another example embodiment of a generating unit 20 in which the magnets 24 are slightly spaced apart on the rotor 22. The stator 26 is comprised of eight bundles 26a of windings (fixed in place) around which the rotor and its magnets 24 rotate. (Each of the eight bundles 26a of stator windings are shown schematically as a circle.) In this example, the rotor 22 is cylindrical in shape (instead of conical) and the magnets 24 are in close proximity to the stator windings (forming the bundles 26a) in order to enhance the amount of magnetic field 28 that passes through the stator windings.

FIG. 9 illustrates another example of a rotor 22 and grate 46. In this example, the grate 46 is constructed to have channels 47 that shunt the air from passing automobiles downward and slightly in the direction of rotor rotation (indicated by arrow B). The rotor 22 includes fins 23 (adjacent the magnets 24) with pockets formed between the fins 23 to receive the air from passing automobiles to thereby urge the rotor 22 to rotate in the direction of arrow B.

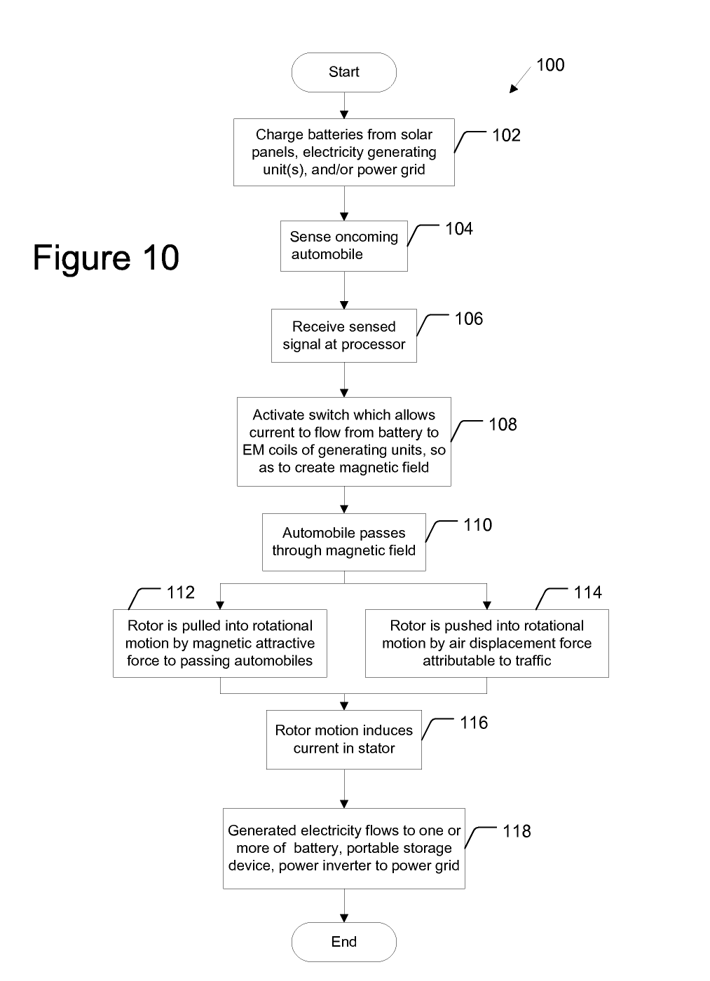

FIG. 10 shows a method 100 for generating electricity according to an example embodiment of the present invention. At step 102 batteries 52 receive charge, such as from the power grid 30, solar panels 50, or electricity generating units 20. At step 104 a sensor 56 detects an oncoming automobile 10 or other assembly. At step 106, a processor 58 of a processing subsystem 60 receives a signal from the sensor 56 indicative of the oncoming automobile 10. At step 108, the processor 58 activates a switch to allow current to flow from a battery 52 to electromagnetic coils mounted or otherwise attached to a rotor 22. The current flows through one or more EM coils on the rotor 22 resulting in creation of a magnetic field 28 adjacent to the electricity generating units 20 at the surface 29 supporting the oncoming automobile. In addition, sensing of the automobile 10 could be used to direct electricity from the battery to the stators to cause the rotors to start turning.

At step 110, the automobile 10 moves through the magnetic field 28. At step 112, the attractive force between the automobile 10 and the rotor magnets 24 (e.g., the EM coils) pulls the rotor 22 into a rotational motion as the automobile 10 passes through the magnetic field. At step 114, an air displacement force 86 attributable to the movement of the automobile 10 in the vicinity of the electricity generating units 20 pushes against the rotor causing the rotor 22 to rotate. In one example embodiment, the rotor 22 has a generally cone shape, and may include other air resistance components (e.g., fan fins) oriented for optimal effect, so as to respond to the wind/air displacement force 86 with a rotary motion.

At step 116, the rotor motion induces a current to flow at the stator 26. At step 118, the generated electricity flows out of the electricity generating unit(s) 20. The generated electricity may be stored in a battery 52 or other power storage device 72. In some embodiments or at some times, the electricity instead may be received at a power inverter 32 which alternates the polarity of the electricity to generate an alternating current which may be coupled to the power grid 30. Accordingly, electricity is generated from the kinetic energy (e.g., attributable to a wind/air displacement force and/or a magnetic attractive force) of a moving vehicle/assembly.

In an alternative embodiment, steps 102-108 and 114 may be omitted, such as for a system in which the rotor 22 includes permanent magnets as the magnet sources 24.

The magnets 24 in the above embodiments form part of the rotor 22 and supply the dual purpose of inducing a current in the stator 26 and causing rotation of the rotor due to attraction to passing vehicles. In another embodiment, the magnets are simply attached to a wheel configured to rotate (due to their attraction to passing vehicles), which turns an axle. The axle is mechanically connected to a generator (the rotor thereof) so that spinning the axle causes the generator to generate electricity. The rotor 22 used in the present invention may employ non-magnetic or magnetic bearings in order to reduce the friction of the rotor 22.

The present invention (the generating units 20) may positioned in any suitable location, but may be especially suitable for locations wherein the passing vehicles are attempting to slow down such as, for example, at exit ramps, at declines, approaching stop signs, approaching traffic lights (in which case the electricity generated can used to help power the traffic lights), approaching toll booths (in which case the electricity generated can used to help power toll booth equipment), approaching speed bumps, approaching sharp turns, entering parking lots, etc.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, steps and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A system for generating electricity from the movement of vehicles over a traveling surface, comprising:
a stator having a winding;
a rotor configured to rotate and configured to be mounted adjacent the traveling surface;
said rotor having a perimeter and a plurality of magnets mounted to said perimeter;
wherein each said plurality of magnet creates a magnetic field and is mounted to said rotor so that the magnetic field of each of said magnets:
(1) induces an electric current in said winding of said stator during rotation of said rotor; and
(2) results in an attractive force between said magnet and the vehicles moving over the traveling surface to urge the rotation of said rotor.

2. The system according to claim 1, wherein said rotor is mounted below the traveling surface and under a non-magnetic grate.

3. The system according to claim 1, further comprising an electric storage device electrically connected to said stator and configured to receive and store electric energy.

4. The system according to claim 1, further comprising a power inverter electrically connected to said stator and configured to receive electricity from said stator.

5. The system according to claim 4, wherein sad power inverter is electrically connected to a public power distribution system to provide power thereto.

6. The system according to claim 1, wherein said stator and rotor form part of a generating unit and said system comprises a plurality of such generating units.

7. The system according to claim 1, wherein said plurality of magnets comprise permanent magnets.

8. The system according to claim 1, wherein said plurality of magnets comprise electromagnets.

9. A system for generating electricity from the movement of vehicles over a traveling surface, comprising:
a rotatable member having a first portion disposed adjacent the traveling surface;
said member having a perimeter and a plurality of magnets mounted to said perimeter;
wherein each said plurality of magnets creates a magnetic field and is mounted to said member so that the magnetic field of said magnet, when located at said first portion of said member, results in an attractive force between said magnet and a vehicle moving over the traveling surface to urge the rotation of said member;
a generator having a rotor and a stator and configured to generate electricity upon rotation of said rotor; and
wherein rotation of said member causes rotation of said rotor to thereby generate electricity.

10. The system according to claim 9, wherein said member forms at least part of said rotor.

11. The system according to claim 9, wherein said member is mechanically coupled to said rotor of said generator.

12. The system according to claim 9, further comprising an electric storage device electrically connected to said stator and configured to receive and store electric energy.

13. The system according to claim 9, further comprising a power inverter electrically connected to said stator and configured to receive electricity from said stator.

14. The system according to claim 9, wherein the system comprises a plurality of said members connected to one or more generators.

15. The system according to claim 9, wherein said plurality of magnets comprise permanent magnets.

16. A method of generating electricity from the movement of vehicles over a traveling surface, comprising:
providing a rotating member having a perimeter and a plurality of magnets mounted to said perimeter;
positioning the rotating member adjacent the traveling surface so that a vehicle moving over the traveling surface passes through a magnetic field of one or more of the plurality of magnets to thereby create an attractive force between the one or more magnets and the vehicle;
rotating the member, at least in part, with the attraction force; and
generating electricity from said rotating of the member.

17. The method according to claim 16, further comprising converting the generated electricity to alternating current electricity.

18. The method according to claim 16, further comprising converting energy from air displaced by the vehicle moving over the traveling surface to electricity.

19. The method according to claim 16, wherein the member comprises a rotor of an electric generating device.

20. The method according to claim 16, further comprising providing the electricity to an electric storage device.

21. The method according to claim 16, wherein the magnets comprise permanent magnets.
